(19) United States
(12) Patent Application Publication
(10) Pub. No.: US 2010/0243691 A1
(43) Pub. Date: Sep. 30, 2010

(54) DISPLACEABLE UTILITY POSITIONING SYSTEM FOR MOTORCYCLES

(76) Inventor: Rick Salisbury, Springville, UT (US)

Correspondence Address: THORPE NORTH & WESTERN, LLP., P.O. Box 1219, SANDY, UT, 84091-1219, US

(21) Appl. No.: 12/732,146

(22) Filed: Mar. 25, 2010

Related U.S. Application Data
(60) Provisional application No. 61/163,418, filed on Mar. 25, 2009.
(60) Provisional application No. 61/312,115, filed on Mar. 9, 2010.

(51) Int. Cl. B62J 9/00; B23P 17/04; B60R 11/00

(52) U.S. Cl. 224/413; 29/428; 224/447; 224/555

(57) ABSTRACT

A positioning system operable about a motorcycle for selectively locating a utility, such as a storage utility or a back rest utility, in one of a plurality of positions about a rear fender of the motorcycle. The positioning system includes a mounting assembly having first and second side mounts securable about opposing sides of the rear fender. The positioning system also includes a carriage configured to support the utility, and which is slidably coupled to the mounting assembly, and which has a range of travel defined by a centerline of the carriage that translating at least the entire length of the side mounts between a most forward position and a most rearward position. The positioning system further includes a riser operable to elevate the carriage above an upper surface of the rear fender, and a locking device that allows the carriage to be locked in a plurality of positions above the rear fender of the motorcycle.

### RELATED APPLICATIONS

This application claims the benefit of U.S. Provisional Application No. 61/163,418, filed Mar. 25, 2009, and U.S. Provisional Application No. 61/312,115, filed Mar. 9, 2010, each of which is incorporated by reference in its entirety herein.

### FIELD OF THE INVENTION

The present invention relates generally to back support systems for riders of motorcycles, and more specifically to displaceable and optionally removable and interchangeable back support systems for riders of motorcycles.

### BACKGROUND OF THE INVENTION AND RELATED ART

Motorcycles are often sold with storage containers or cargo boxes attached to the motorcycle and located behind a single rider, and which are securely mounted with fixed brackets that prevent the often-weighty container from falling off or shifting as the motorcycle is maneuvering along the roadway. If it becomes desirable to add a supplemental passenger seat behind the rider's seat, the cargo box must be completely removed and a different set of brackets installed to relocate the box to a position further back on the motorcycle, or to a rearward position. Making the transition between a one-seat arrangement of the motorcycle and a two-seat configuration can be difficult and time-consuming. In addition, it is not uncommon for such cargo boxes to also provide posterior support to the rider of the motorcycle. Indeed, posterior or back supports may be included, with the cargo box providing the support structure for securing or anchoring the back support. Obviously, once the transition has been made to reposition the cargo box to accommodate a passenger, the posterior support is lost for the rider and is not easily recovered without a similar difficult transition to again locate the cargo box in a forward position.

Previous efforts to provide an adjustable cargo box that can move between the forward and rearward positions without having to remove the container from the motorcycle have been met with limited success, as any adjustable mounting system must be sufficiently robust to secure the cargo box in at least two positions and also guard against the high-vibration operating conditions encountered with motorcycles. If left unaccounted for, the high level of vibration could lead to fatigue and eventual failure of the mechanical components, which could be disastrous for the rider and/or passenger of the motorcycle if the failure occurs while traveling on the open road. In addition, such adjustable systems have also been limited in their range of travel back and forth over the rear fender of the motorcycle and their ability to accommodate riders and passengers of all sizes.

### SUMMARY OF THE INVENTION

In accordance with one representative embodiment described herein, a positioning system is provided for selectively locating a utility component, such as a storage utility (e.g., cargo box, rack, etc.) or a back rest utility, in one of a plurality of positions about a rear fender of a motorcycle. The positioning system includes a mounting assembly having first and second side mounts securable about opposing sides of the rear fender, such as to a frame component of the motorcycle. The positioning system also includes a carriage that is slidably coupled to the mounting assembly and which is configured to support the utility, and which carriage has a range of travel defined by a centerline of the carriage that translates at least the entire length of the side mounts between a most forward position and a most rearward position. The positioning system further includes a riser operable to elevate the carriage above the upper surface of the rear fender, and a locking device that allows the carriage to be locked in a plurality of positions above the rear fender, both in the forward position and the rearward position, as well as in any interim position if desired.

In accordance with another representative embodiment described herein, a displaceable positioning and seating system is provided for selectively locating a utility component in one of a plurality of positions about a rear fender of a motorcycle. The displaceable positioning and seating system includes a mounting assembly having first and second side mounts securable about opposing sides of a rear fender of a motorcycle. The displaceable positioning and seating system also includes a carriage that is slidably coupled to the mounting assembly and configured to support the utility, and a riser that is operable to elevate the carriage above the upper surface of the rear fender. The displaceable positioning and seating system further includes a locking device that allows the carriage to be locked in a plurality of forward and rearward positions above the rear fender, and a passenger seat that removably interfaces with the upper surface of the rear fender upon the carriage being displaced sufficiently rearward to expose an adequate portion of the upper surface of the fender.

In accordance with yet another representative embodiment described herein, a positioning system is provided for selectively locating an interchangeable utility in one of a plurality of positions about a rear fender of a motorcycle. The positioning system includes a mounting assembly having first and second side mounts that are securable about opposing sides of a rear fender of a motorcycle. The positioning system also includes a first carriage portion that is slidably coupled to the mounting assembly and configured to support the interchangeable utility, and with the first carriage portion having a range of travel defined by a centerline of the first carriage portion that translates about at least the entire length of the side mounts between a most forward position and a most rearward position. The positioning system also includes a second carriage portion which is both removably coupled to the first carriage portion and associated with the interchangeable utility, and which has a riser that elevates the interchangeable utility above an upper surface of the rear fender. The positioning system further includes a locking device for locking first and second carriage portions together in a plurality of positions above the rear fender.

In accordance with yet another representative embodiment described herein, a method is provided for selectively displacing a utility component about a rear fender of a motorcycle. The method includes operating a positioning system mounted about the rear fender that is operable to locate the utility in one of a plurality of positions. The positioning system comprises a mounting assembly having first and second side mounts securable about opposing sides of the rear fender, a carriage slidably coupled to the mounting assembly and configured to support the utility, a riser operable to elevate the carriage above the upper surface of the rear fender, and a locking device such that the carriage may be locked in a plurality of forward and rearward positions above the rear fender. The method further includes positioning the carriage and the utility in a rearward position to expose the upper surface of the fender, and attaching a separate, supplemental passenger seat configured to removably interface with the upper surface of the rear fender when the carriage and utility are located in the rearward position. Once in the rearward position, a passenger may further adjust the carriage and the utility to provide the desired posterior support that is most comfortable to the passenger.

In accordance with yet another representative embodiment described herein, a method is provided for selectively displacing a utility component about a rear fender of a motorcycle. The method includes removably coupling a second carriage portion associated with the utility to a first carriage portion that is operable with a positioning system mounted to the rear fender of the motorcycle, and forming a carriage assembly that is operable to locate the utility in one of a plurality of positions about the fender. The method also includes positioning the carriage assembly and associated utility in a rearward position sufficient to expose the fender's upper surface, and attaching a separate, supplemental passenger seat that is configured to removably interface with the upper surface of the fender when the carriage assembly is located in the rearward position. The method further includes adjusting the carriage assembly and associated utility to provide a desired posterior support to a passenger of the motorcycle. The method also includes interchanging the second carriage portion and associated utility with another second carriage portion that is associated with a different utility.

### BRIEF DESCRIPTION OF THE DRAWINGS

Features and advantages of the present invention will be apparent from the detailed description that follows, and when taken in conjunction with the accompanying drawings together illustrate, by way of example, features of the invention. It will be readily appreciated that these drawings merely depict representative embodiments of the present invention and are not to be considered limiting of its scope, and that the components of the invention, as generally described and illustrated in the figures herein, could be arranged and designed in a variety of different configurations. Nonetheless, the present invention will be described and explained with additional specificity and detail through the use of the accompanying drawings, in which:

FIG. 1a illustrates a side view of a motorcycle with a displaceable positioning and seating system in its most forward position, in accordance with one representative embodiment;

FIG. 1b illustrates a side view of a motorcycle with the displaceable positioning and seating system of FIG. 1a in its most rearward position;

FIG. 2 illustrates a side view of two representative utility components, namely a cargo box having a back support and a stand-alone back support, in accordance with another representative embodiment;

FIG. 3a illustrates a close-up, perspective view of the displaceable positioning and seating system of FIG. 1a;

FIG. 3b illustrates a close-up, perspective view of the displaceable positioning and seating system of FIG. 1b;

FIG. 4 illustrates a perspective view of the side mounts and moveable carriage in accordance with one representative embodiment;

FIG. 4a illustrates a close-up, schematic view of the linear bearing sliding mechanism of FIG. 4;

FIG. 5a illustrates a side view of the side mounts and moveable carriage of FIG. 4 with the carriage in its most forward position;

FIG. 5b illustrates a side view of the side mounts and moveable carriage of FIG. 4 with the carriage in its most rearward position;

FIG. 6 illustrates an end view of the side mounts and the moveable carriage of FIG. 4;

FIG. 7 illustrates an end view of the side mounts and the moveable carriage in accordance with another representative embodiment;

FIG. 8a illustrates a close-up, perspective view of the side mounts and moveable carriage in a most rearward position and without the removable seat, in accordance with one representative embodiment; and

FIG. 8b illustrates a close-up, perspective view of the side mounts and moveable carriage of FIG. 8a with the installed removable seat.

FIG. 9 illustrates a side view of a motorcycle with a displaceable positioning and seating system in its most rearward position, in accordance with another representative embodiment;

FIG. 10 illustrates the separated first and second carriage portions of the displaceable positioning and seating system of FIG. 9;

FIG. 11 illustrates the first and second carriage portions of the displaceable positioning and seating system of FIG. 9 being coupled together;

FIG. 12 is a close-up perspective view of the first carriage portion;

FIG. 13 is a close-up perspective view of the front attachment journal on the first carriage portion;

FIG. 14 is a close-up perspective view of the rear attachment journal and coupling stub on the first carriage portion;

FIG. 15 is a close-up perspective view of the front and rear attachment notches and inner coupling device on the second carriage portion, in accordance with another representative embodiment;

FIG. 16 illustrates a step in the method of coupling together the first and second carriage portions of the displaceable positioning and seating system of FIG. 15;

FIG. 17 illustrates another step in the method of coupling the second carriage portion to the first carriage portion;

FIG. 18 is a perspective view of the second carriage portion attached to the bottom of a utility container, in accordance with another representative embodiment;

FIG. 19 is a close-up perspective view of a front attachment notch in the second carriage portion of the seating and positioning system of FIG. 18;

FIG. 20 illustrates the front attachment notch of the second carriage portion engaged with the front attachment journal of the first carriage portion;

FIG. 21 is a close-up perspective view of a rear attachment notch and inner coupling device in the second carriage portion of the seating and positioning system of FIG. 18;

FIG. 22 illustrates a step in the method of coupling together the first and second carriage portions of the displaceable positioning and seating system of FIG. 18;

FIG. 23 is a close-up rear view of the rear attachment notch and inner coupling device in the second carriage portion coupled to the sliding mechanism of the first carriage portion; and

FIG. 24 is a close-up side view of the outer locking device extending from the riser brackets of the second carriage assembly and engaging with a side mount of the mounting assembly.

### DETAILED DESCRIPTION OF REPRESENTATIVE EMBODIMENTS

The following detailed description of representative embodiments of the present invention makes reference to the accompanying drawings, which form a part hereof and in which are shown, by way of illustration, various representative embodiments in which the invention can be practiced. While these embodiments are described in sufficient detail to enable those skilled in the art to practice the invention, it should be understood that other embodiments can be realized and that various changes can be made to the invention without departing from the spirit and scope of the present invention. As such, the following detailed description of the representative embodiments is not intended to limit the scope of the invention as it is claimed, but rather is presented for purposes of illustration, to describe the features and characteristics of the present invention, and to sufficiently enable one skilled in the art to practice the invention. Accordingly, the scope of the present invention is to be defined solely by the appended claims.

Described herein are several representative embodiments of a displaceable positioning and seating system, and methods of using the same, for selectively locating and supporting a “utility” or “utility component” in one of a plurality of positions above or about the rear fender of a motorcycle, and for providing a removable passenger seat that can be attached to the motorcycle behind the driver's/rider's (hereinafter “rider's”) permanent seat when the utility is moved to a rearward position. In one aspect, the utility can include a movable storage utility such as a cargo box or a luggage rack. In another aspect the utility can include a moveable back support utility that can provide posterior support to the lower or other back region of the rider when the utility is moved to the forward position, and which can also provide posterior support to the lower or other back region of a passenger seated on the removable passenger seat when the utility is moved to the rearward position. In yet another aspect, the utility can comprise a moveable storage utility and back support combination or assemblage, in which the back support can extend from the front portion of the storage utility to support the rider or passenger.

Generally, the displaceable positioning and seating system can include a fixed or stationary mounting assembly comprised of two side mounts that secure to the motorcycle in some manner and that are located about opposite sides of the rear fender of the motorcycle. In one aspect the side mounts can be configured to attach to the structural frame of the motorcycle with bolt holes that match the locations of the existing bolt holes or mounting points in the frame, so that installation is made easy. For instance, using pre-existing bolt patterns a user of the system can remove the side fairings or covers secured to the rear fender and attach the side mounts using the pre-existing bolt patterns to begin installing the positioning system to the motorcycle.

The displaceable positioning and seating system can also include a moveable carriage that is slidably coupled to and spans the gap between the two side mounts and over the top of the rear fender. The carriage can provide a top platform surface that is configured to support the utility, and can include projecting blocks or structures that align with and mate to corresponding receptacles formed into the base of the utility, to hold and secure the utility to the back of the motorcycle even when the motorcycle is tilted to one side while riding or when braced on a kick stand at rest.

As stated above, in one aspect the utility can be a storage utility such as an enclosed cargo box that can hold a variety of loose items, or an open luggage rack that allows oversized baggage or objects to be strapped to the storage utility behind the rider and/or passenger. In another aspect, the utility can be a back support utility that is operable with the moveable carriage to selectively provide posterior support to the rider or a passenger, depending upon the position of the utility. Posterior support can be provided to a rider of the motorcycle when the carriage is located in the forward position, and to a passenger of the motorcycle when the carriage is located in a rearward position. And as further stated above, the utility can comprise a combination of the storage and back support utilities such as, for example, a storage container operable with the carriage and including a back support supported about and extending from the front portion of the storage container.

The displaceable positioning and seating system can further include a riser that is operable to elevate the carriage over the top of the rear fender, as the side mounts can be attached low to the sides of the motorcycle at the pre-existing mounting points. The riser can be configured with sufficient height for the carriage to clear the rear fender while moving through its entire range of motion, to avoid contacting or damaging the fender, while still maintaining both the base of the storage utility and the removable passenger seat in as low a position as possible. The riser can be part of either the moveable sliding carriage or part of the fixed mounting assembly.

The moveable carriage can be slidably coupled to the mounting assembly with sliding mechanisms, such as linear bearings, slide rails or similar devices, etc., that allow the carriage to displace back and forth along a single axis of motion. Furthermore, each sliding mechanism can be configured to provide a line of contact or numerous points of contact, rather than just two points of contact, between the fixed mounting assembly and the moveable carriage in order to impart a high degree of structural rigidity and stiffness to the displaceable positioning and seating system along the two axes orthogonal to the axis of motion. In one aspect, a linear bearing sliding mechanism can be telescoping in both directions along the axis of motion, to allow more than half of the length of the sliding rail of the bearing (including the carriage and the attached utility) to extend outwards from the ends of the fixed rail of the bearing in either direction.

The displaceable positioning and seating system can also include one or more locking devices which secure the slidable carriage and the storage utility to the fixed or stationary mounting assembly across a range of positions above the rear fender of a motorcycle. A wide variety of locking devices and methods can be used to secure the slidable carriage and attached storage utility, including mechanisms which provide a continuous range of positions, such as a friction brake, as well as mechanisms which provide a plurality of incremental securable positions separated by discrete intervals, such as a locking plunger with a corresponding series of plunger holes. The locking device can be configured to allow for the easy adjustment of the position of the slidable carriage and the attached utility by a single user, while still protecting against the inadvertent displacement of the moveable components of the positioning system when the motorcycle is in motion.

The displaceable positioning and seating system can also include a removable passenger seat that attaches to the motorcycle behind the permanent rider's seat when the carriage is moved to a rearward position. The removable passenger seat can be configured to attach as low as possible about the upper surface of the rear fender, so as to maintain the center of gravity of the passenger as low as possible relative to the center of gravity of the rider. The bottom surface of the removable passenger seat can conform to the curve in the top surface of the rear fender, and in one aspect can be directly coupled to the upper surface of the rear fender with a suction cup or Velcro-type attachment system, etc. In another aspect, the passenger seat can be mounted directly above the rear fender with a bracket and/or mechanical fasteners, or any other mechanism.

The displaceable positioning and seating system described herein provides several significant advantages over prior-related adjustable motorcycle storage container and seating systems, some of which are recited here and throughout the following more detailed description. Firstly, although the positioning and seating system can be installed and sold with a new motorcycle, it is equally likely that the system will be purchased as an after-market accessory and installed on a used bike. It may be advantageous, in some embodiments, if the displaceable positioning and seating system can be installed and removed without permanently altering or modifying the existing motorcycle, and without the unnecessary replacement of costly secondary components. This can be accomplished by configuring the side mounts of the positioning system to attach at pre-existing bolt locations located on the sides of the motorcycle, coupled with the additional riser which elevates the moveable carriage above the upper surface of the rear fender. Thus, the displaceable positioning and seating system may be installed to the motorcycle with minimum of effort and without any permanent modifications. Also, the moveable carriage can comprise similar mounting locations that correspond to and that utilize pre-existing bolt or other attachment holes in the desired type of utility to be used.

Another significant advantage provided by the displaceable positioning and seating over the prior art is its positioning of the utility and removable passenger seat as low as possible to (or in the case of the passenger seat, even contacting) the rear fender of the motorcycle. This helps to keep the center of gravity of the motorcycle, with the added weight of cargo inside a storage utility or the additional weight of the passenger behind the rider, as low to the ground as possible, which can significantly improve the stability and handling of the motorcycle when operated in the loaded state. Unlike prior art adjustable storage container and seating systems that are supported well above the rear fender, often by reason of the access space needed by their mounting and positioning assemblies, the side mounts and riser of the displaceable positioning system can position the attachment points, the sliding mechanism and the locking device low and to the sides of the rear fender, thus reserving the space above the fender for the moveable carriage and storage box and the replaceable passenger seat. In comparison to other systems, it has been found that this novel configuration can lower the storage utility and passenger seat several inches and lead to a considerable improvement in the stability and handling of the loaded motorcycle.

Yet another advantage afforded by the storage utility and seating system can be the sliding mechanism which allows for an extended range of travel of the moveable carriage and attached utility relative to the length of the fixed side mounts. The sliding mechanism allows for a wide range of adjustable positions without modifying or altering the stability and maneuverability of the motorcycle, and does not obstruct the removable passenger seat or a riding passenger when the carriage is moved to its rearward-most position. In one representative embodiment, this can be accomplished through the use of a sliding mechanism that allows the centerline of the carriage to translate at least the entire length of the side mounts between a most forward position and a most rearward position, so that the front half of the carriage can be substantially cantilevered at or beyond the forward edges of the side mounts in a most forward position, and the back half of the carriage can be substantially cantilevered at or beyond the back edges of the side mounts in a most rearward position. Obviously, other less extensive positions may be achieved by providing adjustment capabilities within by the system, as described herein. Because the carriage slides bi-directionally in a straight line between the most forward and most rearward positions, it can also be locked into a fixed position relative to the mounting assembly anywhere along its range of travel. This allows the motorcycle rider and/or passenger to adjust the position of the back support to accommodate their personal preferences. In one aspect, the adjustment can comprise a plurality of incremental locking positions distributed evenly or otherwise along all or a portion of the carriage's entire extended range of travel. In another aspect, the adjustment can comprise a continuous range of positions afforded by a friction brake or clamping device, etc.

In one representative embodiment, the sliding mechanism of the displaceable positioning and seating system can comprise telescoping linear bearings that allow the centerline of the carriage assembly to move toward and even beyond the forward edges of the side mounts in the most forward position, and toward and even beyond the back edges of the side mounts in the most rearward position. As a result, the carriage with an attached utility, such as a back support utility, can extend forward toward or past the forward edges of the side mounts and over the rear fender (but without contacting the rear fender), to position the utility adjacent the rider, such as to position a back support that provides posterior support to the rider of the motorcycle. When the carriage and attached back support utility are then moved to a rearward position, at least a portion of the upper surface of the rear fender can be exposed to directly receive the removable passenger seat, which can occupy the space previously occupied by the moveable carriage and attached utility. Thus, with the displaceable positioning and seating system described herein there may be no exposed portions of a fixed support assembly remaining above the rear fender and in the way of the removable passenger seat when the carriage and utility are moved to their rearward positions.

Each of the above-recited advantages will be apparent in light of the detailed description set forth below and best understood with reference to the accompanying drawings, wherein the elements and features of the invention are designated by numerals throughout. These advantages are not meant to be limiting in any way. Indeed, one skilled in the art will appreciate that other advantages may be realized, other than those specifically recited herein, upon practicing the present invention.

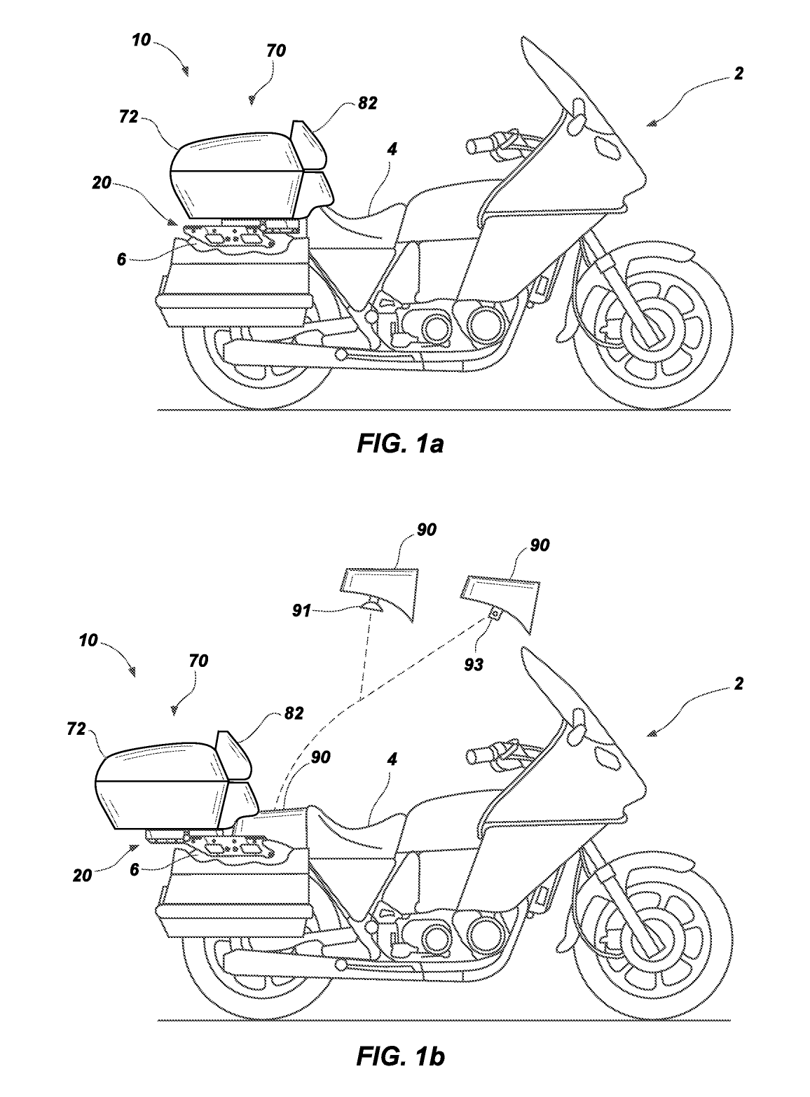

With reference to FIGS. 1a and 1b, illustrated therein is a motorcycle 2 having a displaceable positioning and seating system 10 for selectively locating a utility or utility component 70 in one of a plurality of positions above the rear fender 6 of the motorcycle, in accordance with a representative embodiment. The utility 70 can be supported with a positioning system 20 that is mounted to the motorcycle so as to position it about the rear fender 6. A side view of the motorcycle with the displaceable positioning and seating system 10 in its most forward position is shown in FIG. 1a. The displaceable positioning and seating system in its most rearward position is shown in FIG. 1b, with a removable passenger seat 90 that can be attached to the motorcycle 2 behind the rider's permanent seat 4 when the utility is moved back out of the way.

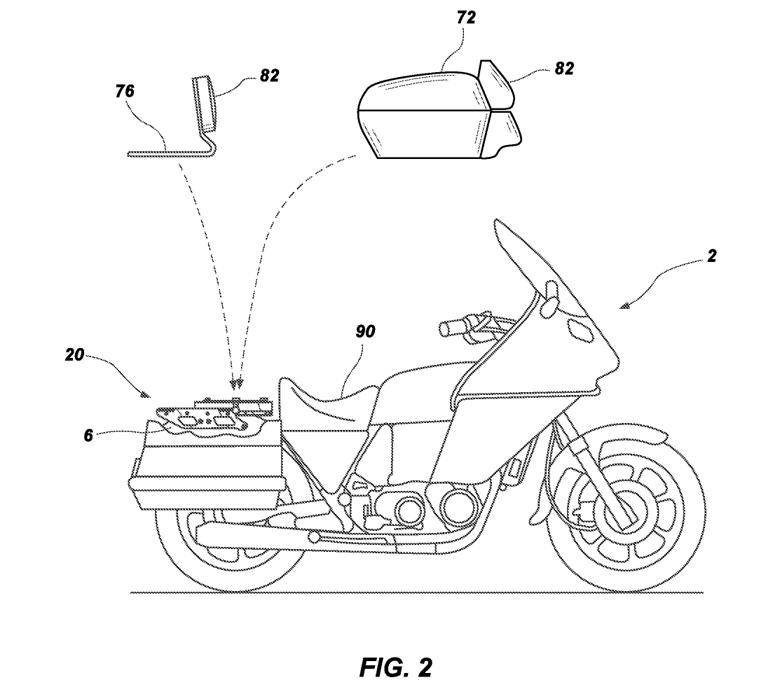

In the representative embodiment shown, the utility 70 can comprise the combination of a moveable storage container 72 and a back support 82 extending from the front portion of the storage container to selectively provide posterior support to a rider seated on the seat 4 when the carriage is located in a forward position, and to provide posterior support to a passenger seated on the removable passenger seat 90 when the carriage is located in a rearward position. As can be appreciated, the storage container 72 or enclosed cargo box can be sized and shaped to hold a variety of loose items, including the removable passenger seat when the displaceable positioning and seating system 10 is located in a forward position. As shown in FIG. 2, however, other utility components can also be attached to the positioning system 20 mounted above the rear fender 6, such as a storage utility comprised of a luggage rack 76 that allows oversized baggage or objects to be strapped to the storage utility behind the rider and/or passenger. The luggage rack 76 can also be combined with a back support utility 82 to selectively support the rider or passenger of the motorcycle.

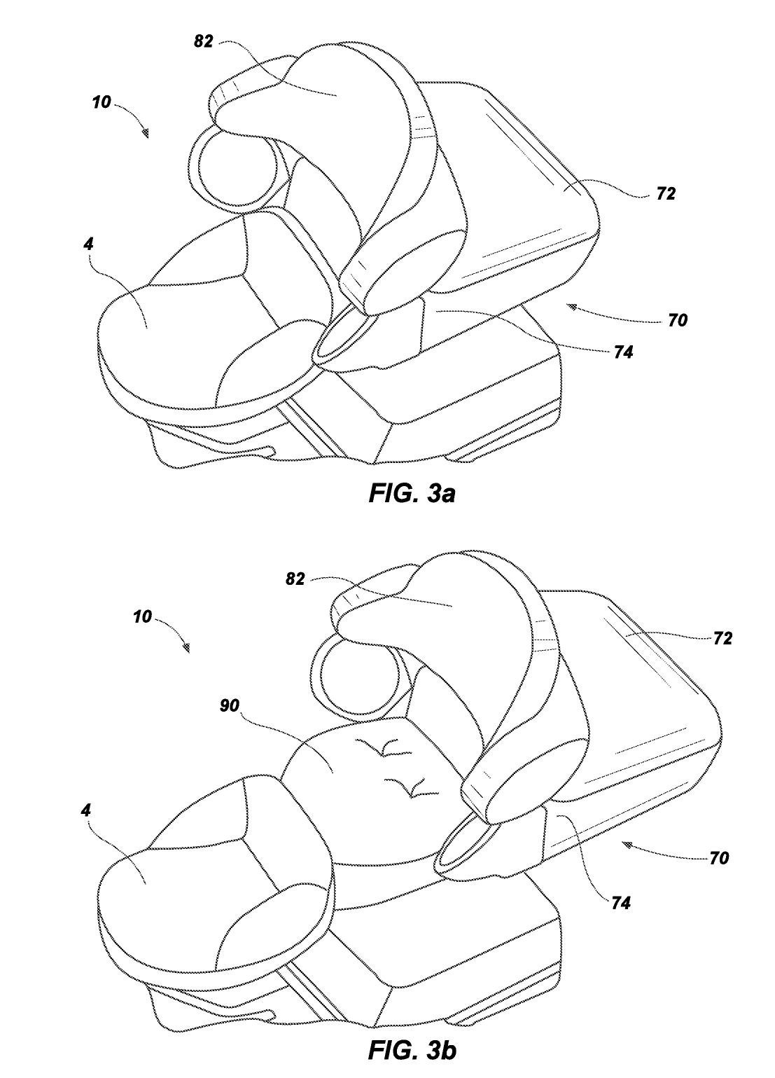

A close-up, perspective view of various motorcycle components (e.g., the seat, a cargo box, a passenger seat) operable with the displaceable positioning and seating system is shown in FIGS. 3a and 3b, respectively, which again illustrates a moveable storage container 72 and back support 82 combination utility having the back support 82 extending from the front portion 74 of the storage container 72 to support the rider in the forward position (FIG. 3a), and to support the passenger in the rearward position (FIG. 3b). As can also be seen, the removable passenger seat 90 can attach directly behind the rider's permanent seat 4 about the rear fender to occupy the space previously occupied by the moveable utility 70. This helps to keep the added weight of the passenger as low to the ground as possible, which can significantly improve the stability and handling of the motorcycle when operated in the two person configuration.

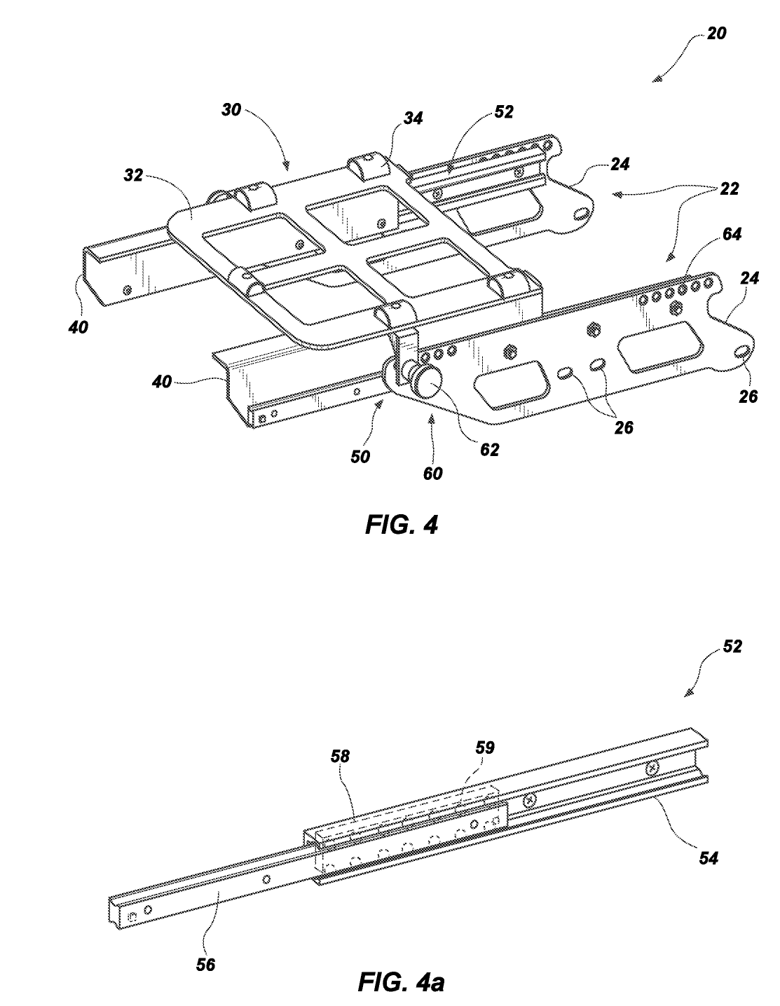

Illustrated in FIG. 4 is a perspective view of the positioning system 20 that allows the position of the utility to be adjusted forward and backward. Generally, the positioning system can include a fixed or stationary mounting assembly 22 comprised of two side mounts 24 that secure to opposite sides of the motorcycle and about the rear fender of the motorcycle (not shown). The side mounts can be configured to attach to the structural frame of the motorcycle with bolt holes 26 that match the locations of the existing bolt holes or mounting points in the frame (e.g., those previously used to secure and attach a stationary cargo box), so that a user of the system can remove the side fairings or covers secured to the rear fender and attach the side mounts 24 using the existing bolt holes to begin installing the positioning system 20 to the motorcycle. The positioning system 20 and side mounts 24 may also be configured to attach to other structural members of the motorcycle, if necessary, using pre-existing or newly formed attachment points.

The positioning system 20 can also include a moveable carriage 30 that is slidably coupled to and that spans the gap between the two side mounts 24 over the top of the rear fender. The carriage can provide a top platform surface 32 that is configured to receive and support the utility, and can include projecting blocks 34 or structures that align with and mate to corresponding receptacles formed into the base of the utility, to hold and secure the utility to the back of the motorcycle even when the motorcycle is leaned to one side while riding or when braced on a kick stand at rest.

The positioning system 20 can further include a riser 40 that is operable to elevate the carriage 30 over the top of the rear fender, as the side mounts 24 can be attached low to the sides of the motorcycle utilizing the pre-existing mounting points. The riser 40 can be configured with sufficient height for the carriage to clear the rear fender while moving through its entire range of motion, to avoid contacting or damaging the fender, while still maintaining both the base of the storage utility and the removable passenger seat in as low a position as possible. As shown in the embodiment 20 of FIG. 4, the riser 40 can be part of the moveable sliding carriage 30. Alternatively, in another aspect the riser can be part of the stationary mounting assembly.

As further illustrated in FIG. 4, the moveable carriage 30 can be slidably coupled to the mounting assembly with a pair of sliding mechanisms 50, such as linear bearings 52. Other sliding mechanisms may comprise slide rails or similar devices, etc., that allow the carriage to displace bi-directionally back and forth along a single axis of motion. Furthermore, each sliding mechanism 50 can be configured to provide a continuous line or region of contact or numerous points of contact, rather than just two points of contact, between the fixed mounting assembly 22 and the moveable carriage 30 in order to impart a high degree of structural rigidity and stiffness to the positioning system 20 along the two axes orthogonal to the axis of motion.

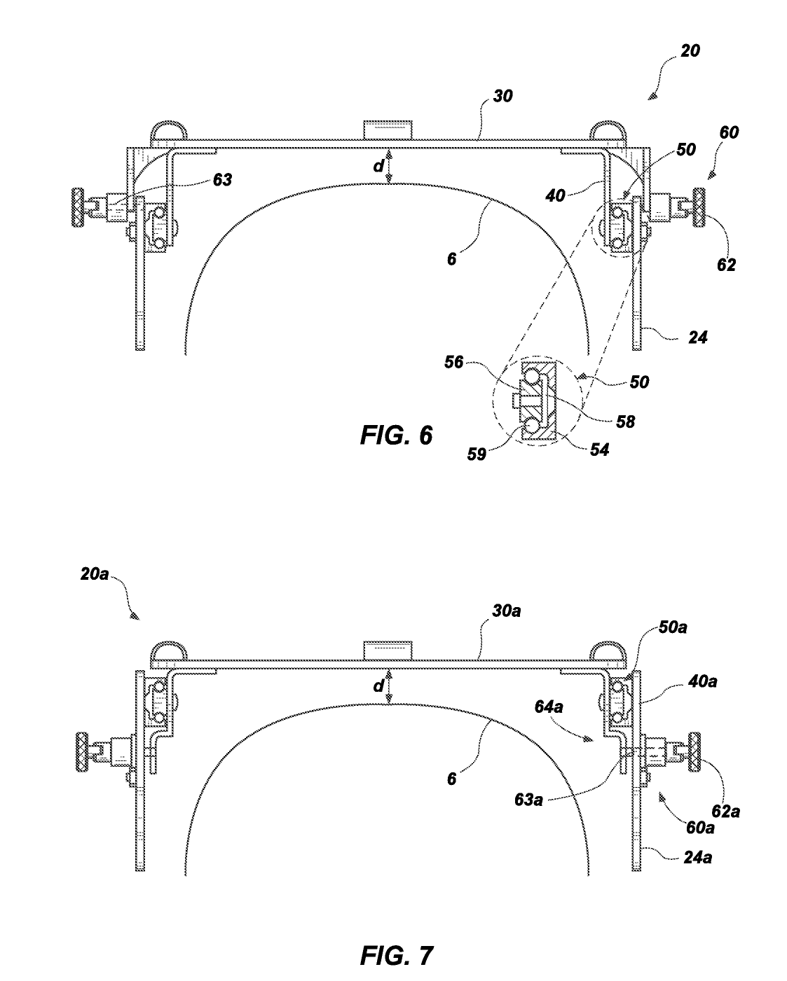

In one aspect illustrated in FIG. 4a, the sliding mechanism 50 can comprise a linear bearing 52 that telescopes in both directions along the axis of motion, to allow more than half of the length of the sliding rail 56 of the bearing (including the carriage and the attached utility) to extend outwards from the ends of the fixed rail 54 of the bearing in either direction (see also detailed cross-sectional view in FIG. 6). The extended range of motion of the telescoping linear bearings allows for the “footprint” of the mounting assembly about the rear fender to be minimized while still providing for an extended range of travel, and while providing more than adequate space for the removable passenger seat. The linear bearing can further comprise a displaceable ball cage 58 holding numerous ball bearings 59 above and below the sliding rail 56, which together provide two lines of contact extending the length of the ball cage.

Referring back to FIG. 4, the positioning system 20 can further include one or more locking devices 60 which secure the slidable carriage 30 and the attached utility to the fixed or stationary mounting assembly 22 in one of a plurality of positions or locations across the extended range of positions above the rear fender of the motorcycle. The locking device can be configured to allow for the easy adjustment of the position of the slidable carriage and the attached utility by a single user, while still protecting against the inadvertent displacement of the moveable components of the positioning system when motorcycle is in motion.

In the embodiment of the exemplary positioning system 20 shown, the locking device 60 can be a spring-loaded locking plunger 62 mounted to the moveable carriage with a corresponding series of plunger holes 64 formed or drilled into the side mounts 24 to provide a plurality of incremental securable positions that are separated by discrete intervals. As can be appreciated by one of skill in the art, the sleeve of the locking plunger can have a notch or recess that allows the knob to be secured in both the unlocked and locked positions.

It is to be further appreciated, however, that a wide variety of locking devices and methods may also be used to secure the slidable carriage and attached storage utility, and which can be considered to fall within the scope of the present invention. For instance, the locking device can include a friction brake or clamping plate device, etc., that allows the moveable carriage 30 to be secured to the mounting assembly 22 across a continuous range of positions.

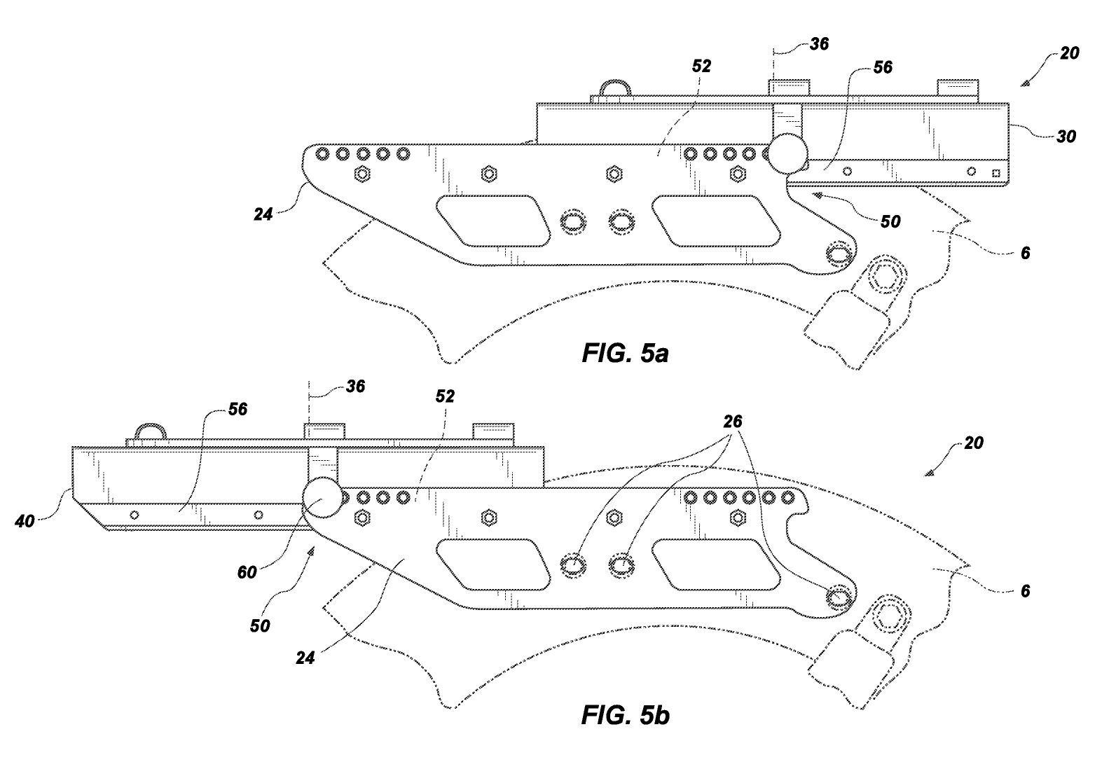

The configuration of the positioning system 20 in the most forward and most rearward positions, and more specifically the relationship between the moveable carriage 30 in relation to the fixed side mounts 24 attached to the frame of the motorcycle adjacent to the sides of the rear fender 6 is illustrated in FIGS. 5a and 5b, respectively. As can be seen, the sliding mechanism 50 can impart a stiffness and rigidity to the positioning system 20 that allows the front half of the carriage 30 to be substantially cantilevered at, near or even beyond the forward edges of the side mounts 24 in the forward position (see FIG. 5a), and the back half of the carriage can be substantially cantilevered at, near or even beyond the back edges of the side mounts in the back position (see FIG. 5b).

When the sliding mechanism 50 is comprised of telescoping linear bearings 52, the stiffness and rigidity can be provided by the dual contact lines of the numerous roller bearings held in place between the sliding inner rail 56 and the stationary outer rail by the ball cage. In one aspect, the extended range of travel afforded by the linear bearing 52 can allow the centerline 36 of the carriage 30 to translate at least the entire length of the bearing portion of the side mounts 24 (such as the fixed rail 54 of the linear bearing shown in FIG. 4a) between a most forward position and a most rearward position. In another aspect, furthermore, the linear bearing and locking device can be configured with a range of motion that operates to cantilever the carriage at least 50% of the length of the carriage beyond a rear-most portion of the side mounts while still maintaining enough stiffness and structural support to avoid any excessive bending and flexing of the sliding mechanism that could result in high-cycle fatigue and lead to the eventual failure of the positioning system 20.

As shown in FIG. 5b, with moveable carriage 30 (and attached utility) in the rear-most position, the side mounts 24 and riser 40 can allow the attachment points 26, the sliding mechanism 50 and the locking device 60 to be located low and to the sides of the rear fender 6, thus reserving the space above the fender for the replaceable passenger seat, and thus not interfering with the placement of the removable passenger seat or a riding passenger. In comparison to other systems, where the exposed portion of the fixed support assembly can remain between the removable passenger seat and the rear fender when the storage utility is moved to its rearward-most position, it has been found that this novel configuration can lower the elevation of the passenger seat several inches, in some cases two to four inches, resulting in a considerable improvement in the stability and handling of the motorcycle.

The function of the riser to elevate the moveable carriage above and to facilitate exposure of the upper surface of the rear fender can be illustrated in FIGS. 6 and 7, in which the riser 40 is part of the moveable carriage 30 in FIG. 6, or the riser 40a is part of the fixed side mounts 24a in FIG. 7. In both cases, referring to both FIGS. 6 and 7, respectively, the fixed side mounts 24, 24a are attached to the frame of the motorcycle adjacent to the sides of the rear fender 6, the moveable carriage 30, 30a is positioned above the fender a minimal distance d, and the locking device 60 extends from the outer surface of the positioning system 20, 20a to allow for the easy adjustment of the position of the carriage 30 and the attached utility by a single user. With the riser 40 part of the moveable carriage 30 (FIG. 6) the sliding mechanism 50 (shown as a linear bearing with fixed rail 54, and sliding rail 56, with the displaceable ball cage 58 holding numerous ball bearings 59 above and below the sliding rail 56) can be located at least partially below the locking device 60, with a locking plunger 62 and plunger pin 63.

With the riser 40a being a part of the fixed side mounts 24a (FIG. 7), the sliding mechanism 50a can be located above the locking device 60a. FIG. 7 also illustrates the locking plunger 62a with plunger pin 63a that interfaces with the plunger hole 64a (which is shown as part of the moveable carriage 30a) to facilitate adjustment of the carriage 30a.

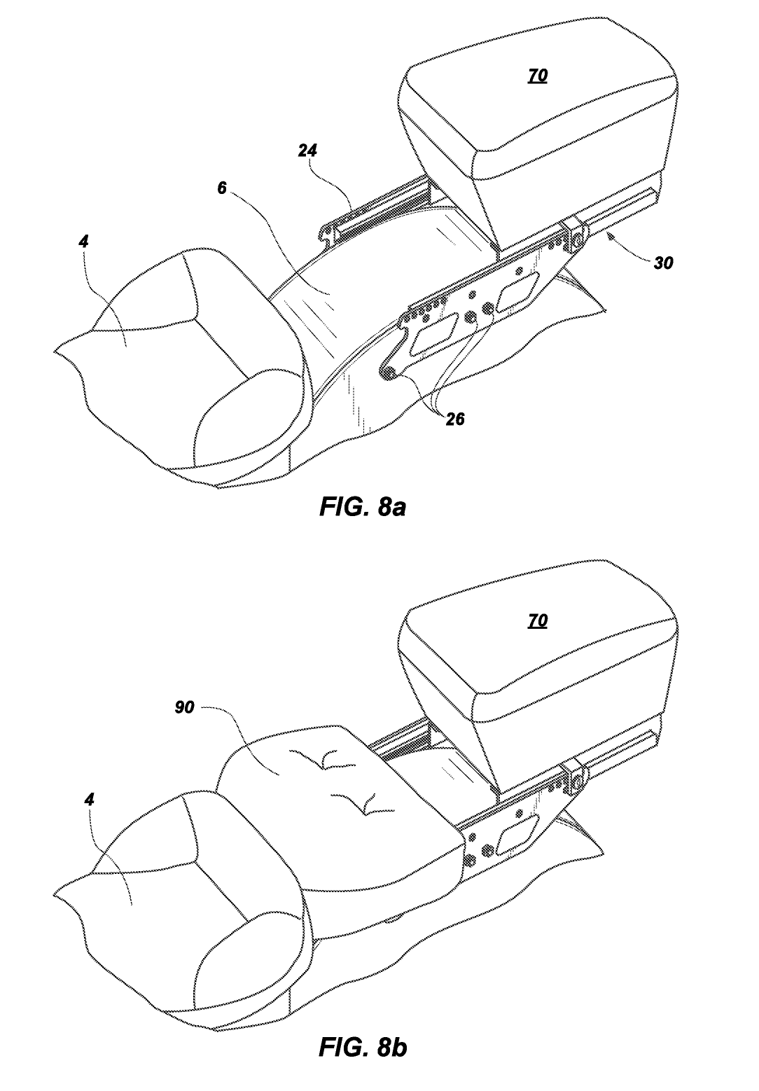

The attachment of the removable passenger seat can be illustrated in more detail with a close-up, perspective view of the side mounts and moveable carriage in a most rearward position and without the removable seat shown in FIG. 8a, and with the installed removable seat shown in FIG. 8b. (In the figures the back support has been removed from the front of the utility for purposes of clarity.)

As can be seen in FIG. 8a, with the moveable carriage 30 (and attached utility 70) in the rear-most position, the upper surface of the rear fender 6 is exposed and un-occupied by the fixed mounting assembly. Indeed, only the top surfaces of the side mounts 24, which are attached at attachment points 26 can have an elevation that is level with or below the upper surface of the rear fender, are visible. This can allow the removable passenger seat 90 to be attached as low to the upper surface of the rear fender as would otherwise be possible if no positioning system were attached (FIG. 8b), so as to maintain the center of gravity of the passenger as low as possible relative to the center of gravity of the rider. The bottom surface of the removable passenger seat can conform to the curve in the top surface of the rear fender, and can contact and be directly coupled to the upper surface of the rear fender with a suction cup or hook and loop (e.g., Velcro) type attachment system, etc. In another aspect, the passenger seat can also be mounted directly above the rear fender with a bracket and/or mechanical fasteners. Referring back to FIG. 1b, seat 90 is shown as being attachable to the rear fender via a suction cup 91 or a bracket assembly 93.

The removable rear passenger seat 90 is operable with a corresponding rider's seat 4 that is appropriately configured to accommodate the rear passenger seat 90, as well as to not interfere with the carriage, the utility or any aspect of the positioning system. The rider's seat 4 may be a two-piece design, with the rider's and passenger's seats being formed from an original seat where the two seating areas were originally part of the same seat. In other words, it is contemplated that the positioning system may be provided aftermarket, with an existing seat being converted into two seats to permit the forward positioning of the carriage and the utility and the selective removability of the passenger seat. Alternatively, the rider's and/or the passenger seat may be originally independent of one another, such as the two seats 4, 90 comprising a custom design.

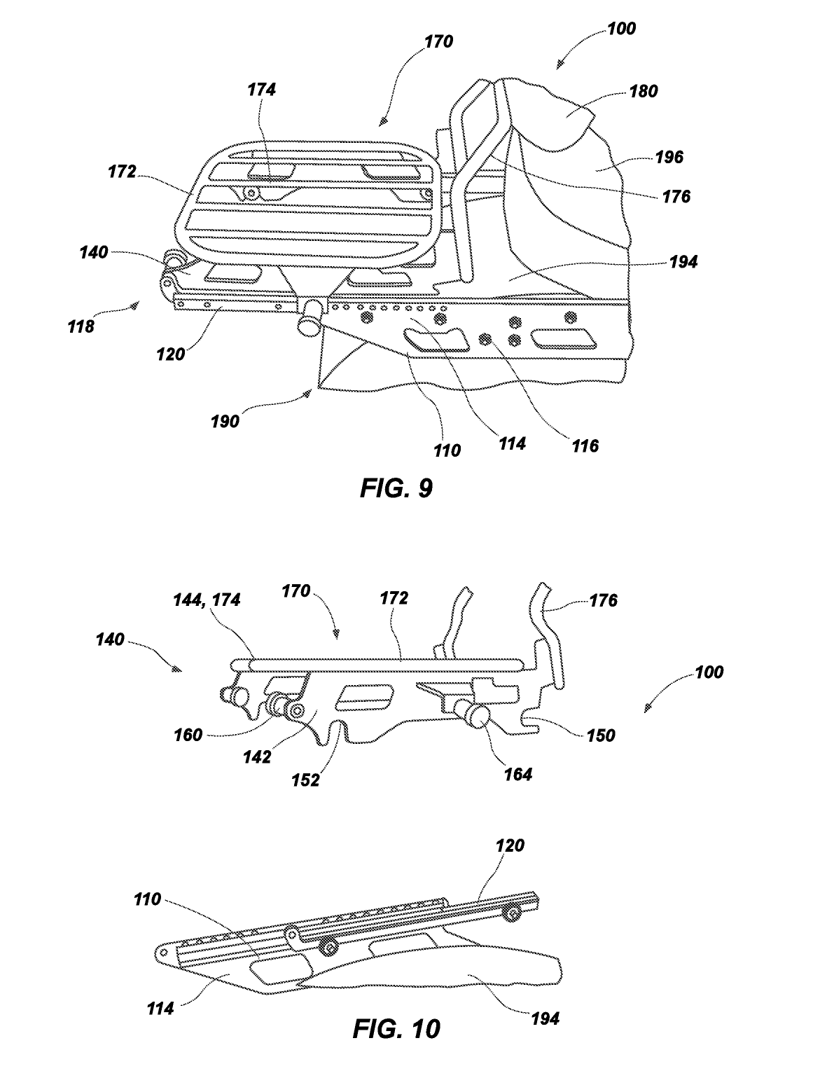

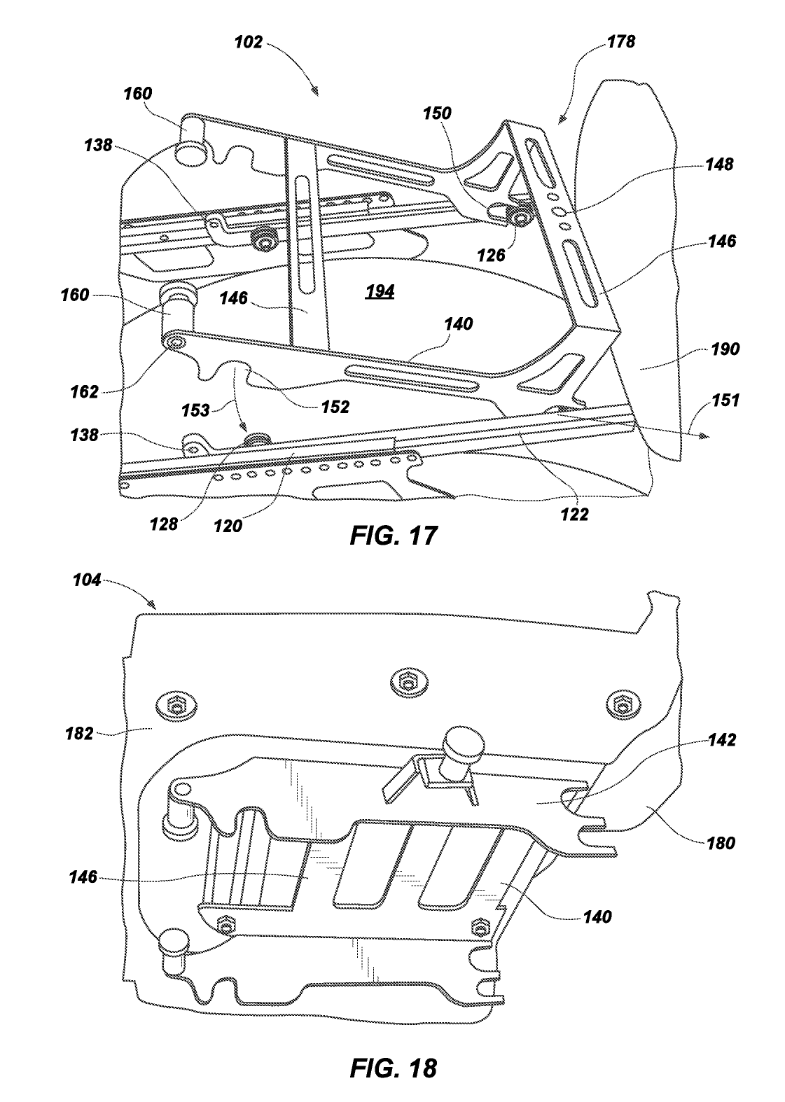

Illustrated in FIGS. 9-24 are additional representative embodiments of the displaceable positioning and seating system described herein, each having a carriage assembly separated into a first carriage portion 120 that is slidably coupled to the mounting assembly 110, and a second carriage portion 140 which is removably coupled to the first carriage portion. These embodiments allow for a plurality of interchangeable second carriage portions 140 carrying different utilities 170 to be attached to and removed from the same sliding first carriage portion 120, so that a variety of utilities can be interchangeably and slidably mounted above the rear fender 194 of the same motorcycle 190 or another motorcycle using the same displaceable positioning and seating system.

FIG. 9 illustrates a side view of a motorcycle displaceable positioning and seating system 100 in its most rearward position above the rear fender 194 of a motorcycle 190, in accordance with one representative embodiment. The displaceable positioning and seating system 100 includes a mounting assembly 110, a first carriage portion 120, a second carriage portion 140 removably coupled to the first carriage portion, and a utility 170 mounted to the second carriage portion. The utility 170 shown in FIG. 9 can comprise a luggage rack utility 172 having a horizontal and flat luggage platform 174 with vertical braces 176 extending upwards from a front portion of the utility to elevate a back support utility 180 to a comfortable height for the rider. When moved to its most rearward position, the coupled first and second carriage portions, or carriage assembly 118, can be positioned above and behind the rear fender to allow a removable passenger seat 196 to placed over the top of the rear fender 194 behind the rider's seat (not shown).

As with the embodiments described above, the fixed or stationary mounting assembly 110 can be comprised of two side mounts 114 that are secured to opposite sides of the motorcycle 190 and about the rear fender 194 of the motorcycle. The side mounts can be configured to attach to the structural frame of the motorcycle with bolt holes 116 that match the locations of the existing bolt holes or mounting points in the frame (such as those previously used to secure and attach side fairings or a cargo box), so that a user of the system may only be required to remove the side fairings or covers bolted to the rear fender and attach the side mounts 114 in their place to install the mounting assembly 110 to the motorcycle. Alternatively, the side mounts 114 of the mounting assembly may also be configured to attach to other structural members of the motorcycle using either pre-existing or newly formed attachment points, or both, if necessary.

The second carriage portion 140 which supports the utility 170 can be separated from the first carriage portion 120 that is slidably coupled to the mounting assembly 110 having side mounts 114, as shown in FIG. 10. As can be seen, the second carriage portion 140 can include a pair of riser brackets 142 that are joined together by a top platform surface 144 that spans the distance between the two riser brackets above the rear fender 194. The riser brackets can be configured with sufficient height for the second carriage portion 140 and attached utility 170 to clear the rear fender 194 while moving through its entire range of motion, to avoid contacting or damaging the fender, while still maintaining both the base of the utility 170 and the removable passenger seat in as low a position as possible.

As shown in FIGS. 9 and 10, the utility 170 and second carriage portion 140 can be integrated together into one assembly that performs the functions of both components. For instance, the top platform surface 144 of the second carriage assembly can also function as the horizontal luggage rack platform 174, and thus provide both the structural framework for the second carriage portion as well as the storage space location for the luggage rack utility 172. Additionally, a forward portion of the pair of riser brackets 142 can also be configured to support the vertical braces 176 which elevate the back support utility. In other embodiments the second carriage portions and the utility can be configured as separate components, as will be described hereinbelow.

The second carriage portion 140 can include front 150 and rear 152 attachment sites or notches formed into each riser bracket, respectively which are used to couple the second carriage portion to the first carriage portion, as well as an inner coupling device 160 which removably secures or locks the two carriage portions together to form the carriage assembly. Also shown in FIG. 10 is an outer locking device 164 that can be used to secure the carriage assembly and its attached (or integrated) utility 170 to the fixed or stationary mounting assembly 110 in one of a plurality of positions across the extended range of positions above the rear fender of the motorcycle.

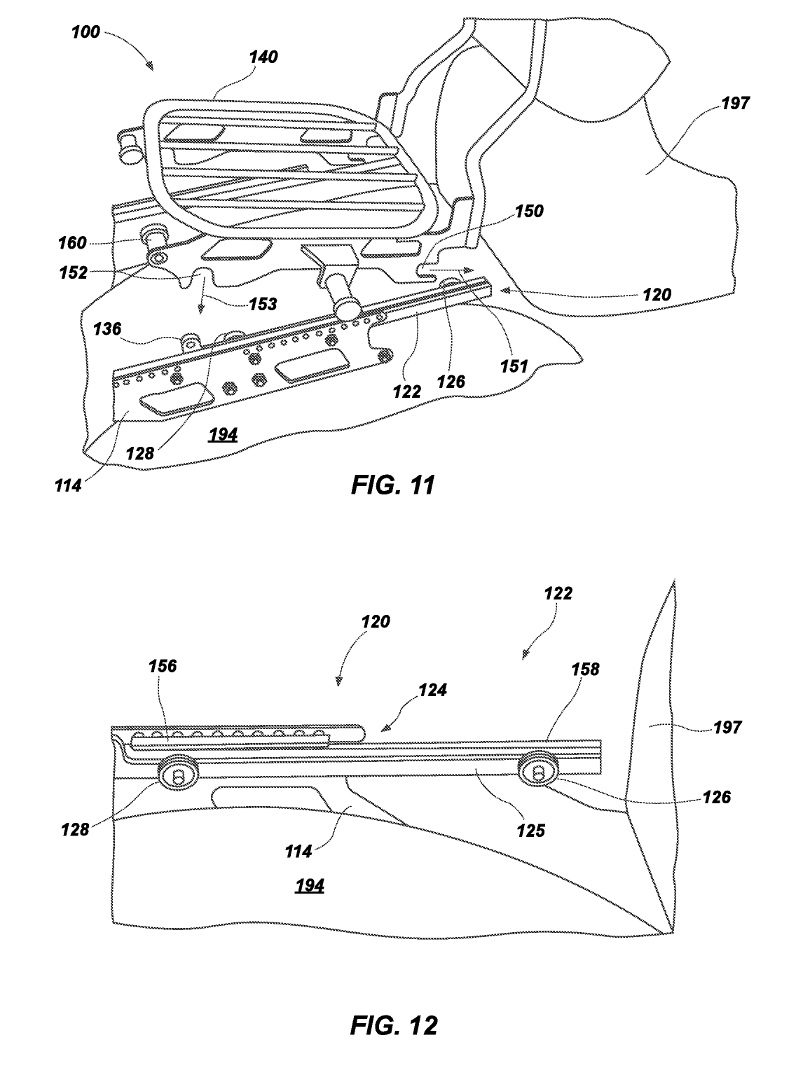

In one aspect the front attachment notches 150 formed into the riser brackets 142 can open in a forward direction, while the rear attachment notch 152 can open in a downward direction that is transverse or orthogonal to the opening direction of the front attachment notch. The benefits of this configuration is shown in FIG. 11, in which the second carriage portion 140 can be attached to the first carriage portion 120 above the rear fender 194 by tilting the second carriage portion (and its attached utility) at an angle relative to the first carriage portion, and then moving the second carriage portion in a forwardly and downwardly direction 151 until the front attachment notches 150 engage with a set of front attachment journals 126 extending inwardly from the front portions of the sliding mechanisms 122 of the first carriage portion 120. The second carriage portion can then be rotated downwardly 153 until the rear attachment notches 152 engage with a set of rear attachment journals 128 extending inwardly from the rear portion of the sliding mechanisms 122. A stable four-point interconnection (e.g. two attachment points per side) can thus be established between the second carriage portion 140 and the sliding mechanisms 122 of the first carriage portion 120.

As can also be seen in FIG. 11, in one aspect both sliding mechanisms 122 of the first carriage portion 120 can be moved to their furthest forward positions adjacent the rider's seat 197 and abutting a pair of linear bearing forward stops prior to attaching the second carriage portion 140, so as to provide the second carriage portion 140 with resistance and leverage sufficient to couple the two carriage portions together.

To enhance the interconnection, the second carriage portion can be further secured to the first carriage portion with the inner coupling devices 160, which devices operate to lock the first and second carriage portions together with a six-point interconnection. As shown in FIG. 11, the inner coupling devices 160 of the second carriage portion 140 can be coupled to the sliding mechanism 122 at the coupling stub 136, which may also be located rearward of the rear attachment journals 128 in the embodiment 100 to provide a longer stance or base that better stabilizes and secures the carriage assembly.

The sliding mechanism 122 of the first carriage portion 120 is shown with more detail in FIG. 12, and can provide the positioning system with a stiffness and rigidity sufficient to allow the front half of the carriage assembly to be substantially cantilevered at, near or even beyond the forward edges of the side mounts 114 in the forward position, and the back half of the carriage assembly to be substantially cantilevered at, near or even beyond the back edges of the side mounts in the back position. In the embodiment illustrated in FIG. 12 the sliding mechanism 122 can include a linear bearing 124 having a stationary outer rail 156 attached to the inner side or face of the side mounts 114, and a sliding inner rail 158 attached to a coupling bar 125 from which extends the front and rear attachment journals 126, 128, respectively.

As described above, the stiffness and rigidity of the sliding mechanism 122 can be provided by the dual contact lines of the numerous roller bearings held in place between the sliding inner rail 158 and the stationary outer rail 156 by a ball cage. In one aspect, the extended range of travel above fender 194 afforded by the linear bearing 124 can allow the centerline of the carriage assembly to translate at least the entire length of the side mounts 114 between a most forward position and a most rearward position. In another aspect, the linear bearing and locking device can be configured with a range of motion that operates to cantilever the carriage at least 50% of the length of the carriage beyond a rear-most portion of the side mounts while still maintaining enough stiffness and structural support to avoid any excessive bending and flexing of the sliding mechanism 122 that could result in high-cycle fatigue and lead to the eventual failure of the positioning system.

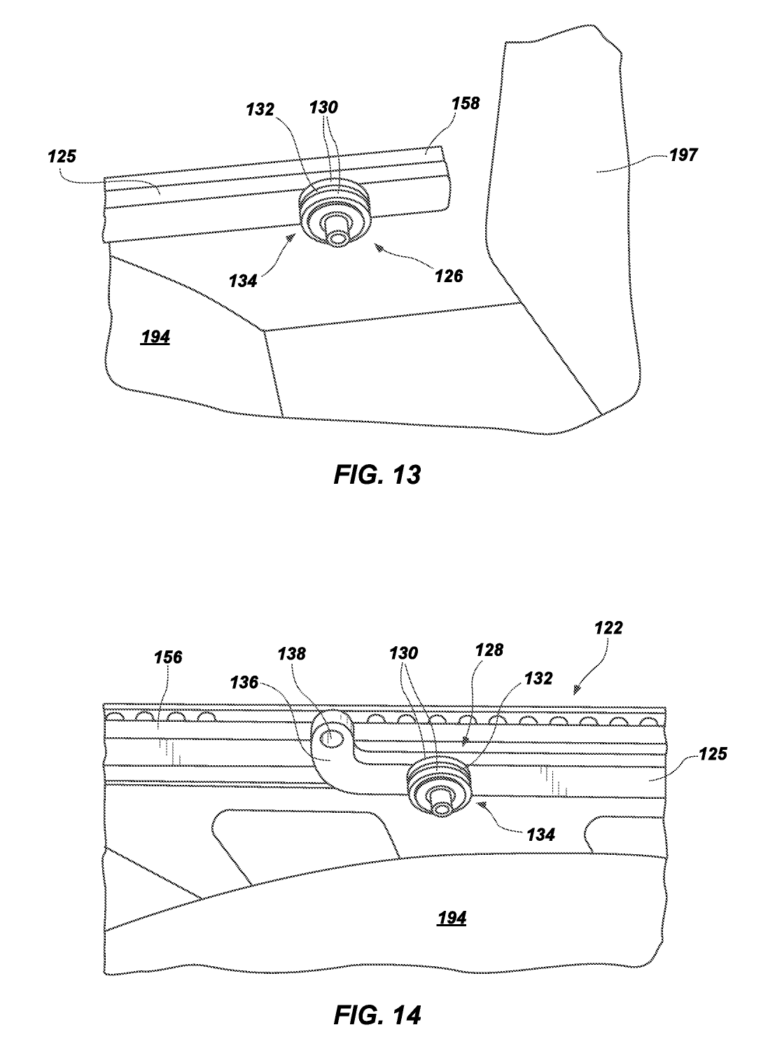

Further illustrated in FIGS. 13 and 14 are close-up perspective views of the front attachment journal 126 and the rear attachment journal 128, respectively, extending from the coupling bar 125, which is adjacent the inner race 158, and which are shown as operating about the fender 194. Each attachment journal can include side disks 130 attached to either end of the journal to form an attachment groove 132, so that the inside edges of the attachment notches formed into the riser brackets can fit snuggly around the attachment journals 126, 128 while the vertical surfaces of the riser brackets immediately adjacent the attachment notches are received into the attachment grooves 132. This can create a stable interconnection that may only be disengaged by moving the riser brackets in a reverse direction to cause the attachment notches to slide out from around the attachment journals.

In one aspect the attachment journals 126, 128, including the side disks 130, can be formed from an elastomeric material or coated with an elastomeric coating to form elastomeric grommets 134, so that the attachment notches interconnect with the attachment journals with a flexible interference fit that eliminates or reduces metal-on-metal contact between the two structures. This allows the second carriage portion to be removably secured to the sliding mechanism of the first carriage portion with a rigid but resilient interconnection that can both dampen vibration traveling upwards from the motorcycle below, and reduce or eliminate any sliding metal-on-metal contact that could wear down or loosen the interference fit interconnection over time, and eventually lead to premature failure.

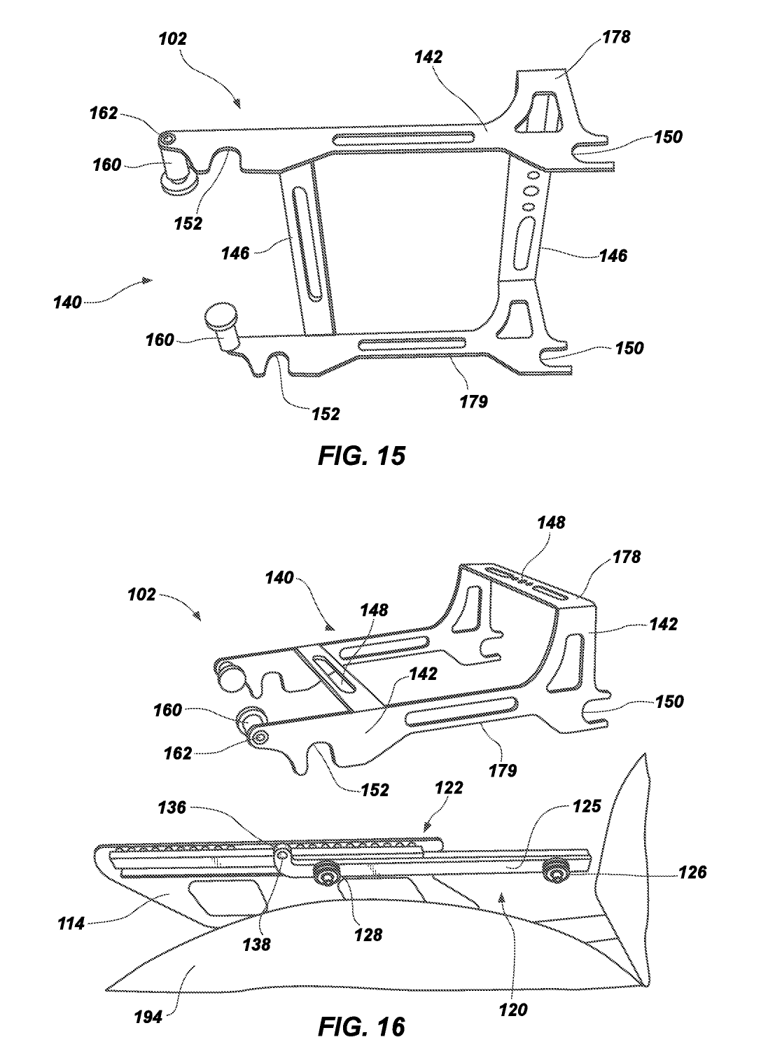

Referring now to FIG. 14, the rear portion of the coupling bar 125 (again adjacent the inner race 158 which operates with outer race 156 of the telescoping linear bearing) of the sliding mechanism 122 can further include an upwardly-directed coupling stub 136 having a pin hole 138 formed therein. The pin hole can be configured to receive a spring-loaded pin 162 or plunger from the inner coupling device 160 attached to the second carriage portion 140 shown in FIG. 15.

Referring now to FIG. 16, once the attachment notches 150, 152 formed into the riser brackets 142 have been caused to engage the attachment journals 126, 128, respectively, extending inwardly from the coupling bars 125, the spring-loaded pins 162 can be inserted into the pin holes 138 to lock the removable second carriage portion 140 to the sliding mechanisms 122 located about the side mounts 114 on both sides of the fender 194, and thus prevent the second carriage portion 140 from rotating upwards relative to the first carriage portion 120 in a manner that would disengage the interconnections.

FIGS. 15-17 also serve to illustrate another embodiment 102 of the displaceable positioning system and seating system that includes a different type or configuration of a utility 178 which can be used to attach a shell (not shown) of a different type (e.g., a shell having smaller dimensions) above the rear fender 194 of the motorcycle 190. The smaller utility 178 can be attached to or integrated with the second carriage portion 140 so that the riser brackets 142 are connected together with cross bars 146 to form a frame 179 having bolt holes 148 formed into the forward cross-bar which can be used attach the shell to the utility 178. The riser bracket comprises rear attachment notches 152 and front attachment notches 150.

Like the previously-described embodiment, the utility 178/second carriage portion 140 can be coupled to the first carriage portion 120 by first moving the sliding mechanism 122 of the first carriage portion to a most forward position against a forward stop (see FIG. 16).

The utility 178/second carriage portion 140 can then be tilted at an angle relative to the first carriage portion 120 while moving the second carriage portion in a forwardly direction 151 (relative to the second carriage portion) until the front attachment notches 150 engage with a set of front attachment journals 126 formed into the sliding mechanism 122 of the first carriage portion 120. The second carriage portion 140 can then be rotated downwardly 153 until the rear attachment notches 152 engage with a set of rear attachment journals 128 also extending from the sliding mechanism 122. Finally, the spring-loaded pins 162 in the inner coupling devices 160 can be inserted into the pin holes 138 in the sliding mechanism 122 to lock and secure the first and second coupling portions together.

The reverse procedure of disengaging or removing the spring-loaded pins 162 from the pin holes 138, rotating the rear attachment notch 152 up and away from the rear attachment journal 128, and sliding the front attachment notch 150 back and away from the front attachment journal 126 can be used to remove or decouple the second carriage portion 140 from the first carriage portion 120.

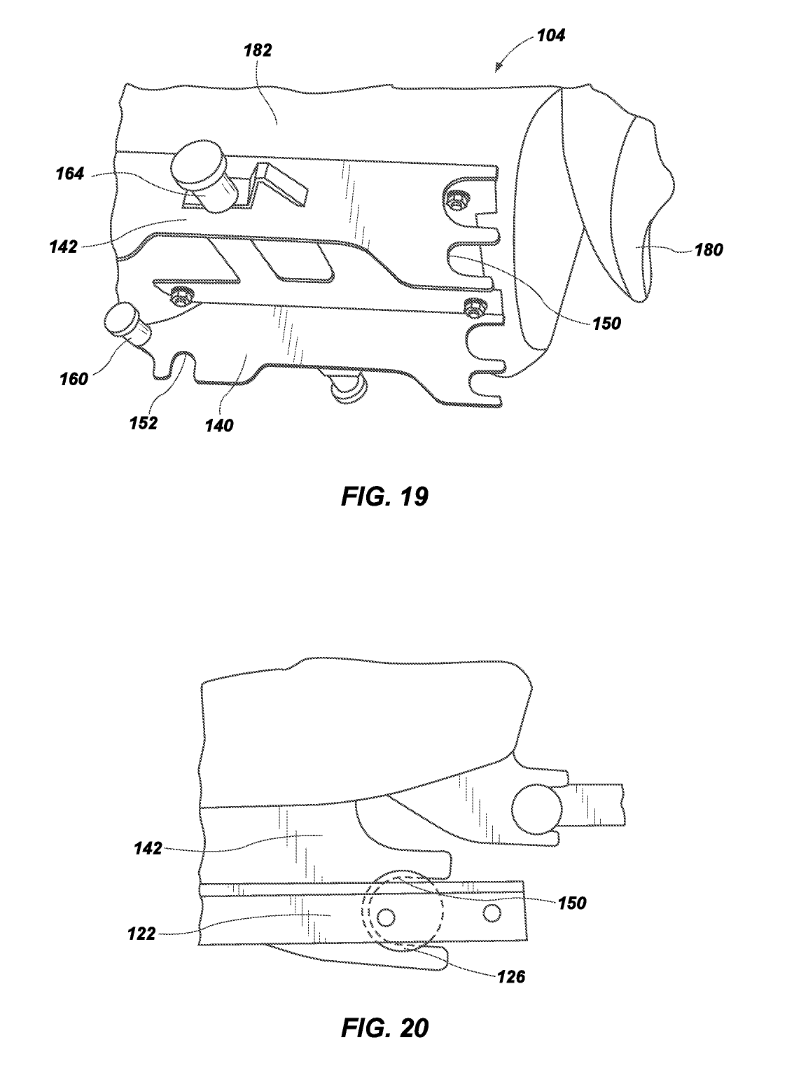

Illustrated in FIGS. 18-19 is yet another embodiment 104 of the displaceable positioning system and seating system, which comprises a cargo box utility 182 which can be used to hold or store cargo above the rear fender of the motorcycle. The removable second carriage portion 140 can have two riser brackets 142 and a plurality of cross bars 146, and can be attached to the bottom of the cargo box utility 182. In addition, a back support utility 180 can be attached to the front of the cargo box utility.

FIG. 19 is a close-up, perspective view of the second carriage portion 140 which better illustrates the front 150 and rear 152 attachment notches formed into the riser brackets 142. Also shown is an inner coupling device 160 attached to the rear portion of one riser bracket, and which can be used to removably couple the second carriage portion (and attached utility 182) to the first carriage portion. Further shown are the outer locking devices 164 attached to the center portion of the riser brackets 142, and which can be used to secure the coupled carriage assembly and the attached utility in one of a plurality of positions or locations across the extended range of positions above the rear fender of the motorcycle. The outer locking device 164 can be configured to allow for the easy adjustment of the position of the slidable carriage assembly and the attached utility by a single user, while still protecting against the inadvertent displacement of the moveable components of the positioning system when motorcycle is in motion.

FIG. 20 is a close-up side view of the front attachment notch 150 of a riser bracket 142 after engagement with the front attachment journal 126 extending inwardly from the sliding mechanism 122 of the first carriage portion.

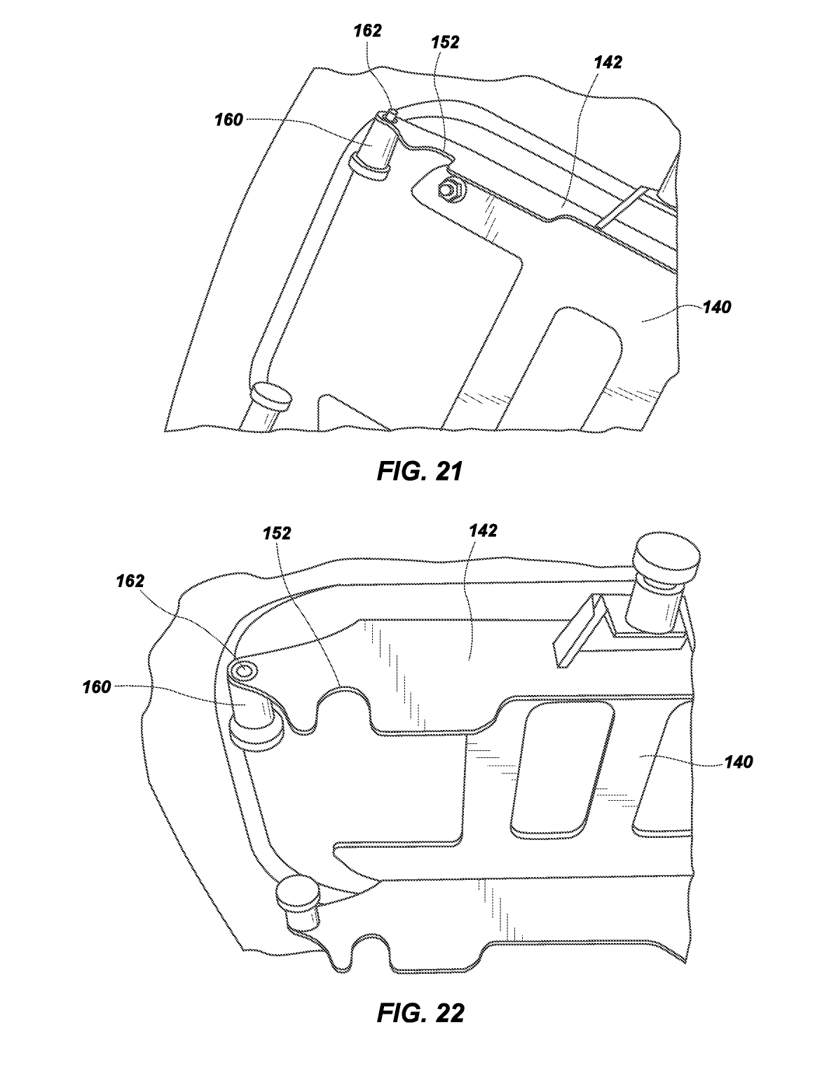

FIGS. 21 and 22 are close-up bottom views of the rear attachment notch 152 and inner coupling device 160 of a riser bracket 142, prior to engagement with the sliding mechanism of the first carriage portion. The spring-loaded coupling pin 162 or plunger shown in FIG. 21 can be manually retracted into the inner coupling device 160 prior to installing the second carriage portion 140 into the first carriage portion, as shown in FIG. 22, so that the rear attachment notch 152 can be fully seated and engaged with the rear attachment journal when forming the carriage assembly. The coupling pin or plunger 162 can then be released into the coupling bar pin hole to lock the second carriage portion together with the first carriage portion.

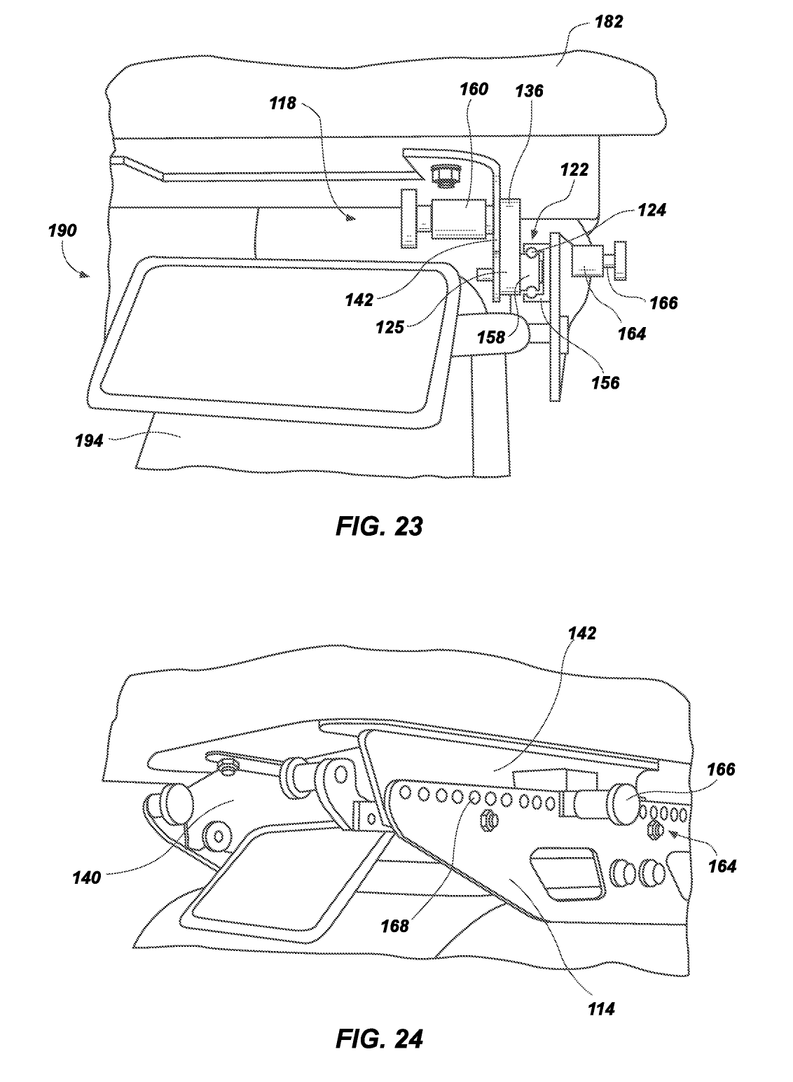

Illustrated in FIGS. 23 and 24 are rear and perspective views of the assembled carriage assembly 118 which slidably supports the cargo box utility 182 above the rear fender 194 of the motorcycle 190. The position of the inner coupling device 160 is best seen in FIG. 23, where the spring-loaded coupling pin is inserted into the pin hole formed into coupling stub 136 extending upwards from the rear portion of the coupling bar 125. The back edge of the riser bracket 142 can also be seen, as well as the ends of the inner 158 and outer 156 races of the telescoping linear bearing 124 forming the sliding mechanism 122 in the first carriage portion.

The outer locking device 164 can be a spring-loaded locking plunger 166 mounted to the riser bracket 142 of the second carriage portion 140, and can interface with a corresponding series of plunger holes 168 formed or drilled into the side mounts 114 to provide a plurality of incremental securable positions that are separated by discrete intervals. The series of plunger holes can also provide the carriage assembly with a range of travel defined by a centerline of the first carriage portion that translates about at least the entire length of the side mounts 114 between a most forward position and a most rearward position. As can be appreciated by one of skill in the art, the sleeve of the outer locking device can have a notch or recess that allows the knob to be secured in both the unlocked and locked positions. In another aspect the positional adjustments provided by the outer locking device 164 interfacing with the side mounts 114 can comprise a continuous range of positions, such as that afforded by a friction brake or clamping device, etc.

The foregoing detailed description describes the invention with reference to specific representative embodiments. However, it will be appreciated that various modifications and changes can be made without departing from the scope of the present invention as set forth in the appended claims. The detailed description and accompanying drawings are to be regarded as illustrative, rather than restrictive, and any such modifications or changes are intended to fall within the scope of the present invention as described and set forth herein.

More specifically, while illustrative representative embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, any steps recited in any method or process claims may be executed in any order and are not limited to the order presented in the claims. The term “preferably” is also non-exclusive where it is intended to mean “preferably, but not limited to.” Accordingly, the scope of the invention should be determined solely by the appended claims and their legal equivalents, rather than by the descriptions and examples given above.

What is claimed and desired to be secured by Letters Patent is:

1. A positioning system operable about a motorcycle for selectively locating a utility in one of a plurality of positions, said positioning system comprising:
a mounting assembly having first and second side mounts securable about opposing sides of a rear fender of a motorcycle;
a carriage slidably coupled to said mounting assembly and configured to support said utility, wherein said carriage comprises a range of travel defined by a centerline of said carriage that translates about at least the entire length of said side mounts between a most forward position and a most rearward position;
a riser operable to elevate said carriage above an upper surface of said rear fender; and
a locking device such that said carriage may be locked in a plurality of positions above said rear fender.

2. The positioning system of claim 1, wherein said carriage is slidably coupled to said mounting assembly using linear bearings having a range of motion that operates to cantilever said carriage at least 50% of the length of said carriage beyond a rear-most portion of said side mounts.

3. The positioning system of claim 1, wherein a position of said carriage within said range of travel is variable one of incrementally and continuously between said most forward position and said most rearward position.

4. The positioning system of claim 1, further comprising a passenger seat that removably interfaces with said upper surface of said rear fender upon said carriage being displaced sufficiently rearward to expose an adequate portion of said upper surface of said fender.

5. The positioning system of claim 4, wherein said passenger seat directly contacts said upper surface of said rear fender.

6. The positioning system of claim 4, wherein said utility comprises a back support operable with said carriage to selectively provide posterior support to a rider of said motorcycle when said carriage is located in a forward position, and to provide posterior support to a passenger of said motorcycle when said carriage is located in a rearward position.

7. The positioning system of claim 6, wherein said utility comprises a storage container operable with said carriage, and wherein said storage container comprises a back support supported about and extending from said storage container.

8. The positioning system of claim 1, wherein said first and second side mounts are securable about said opposing sides of said rear fender using pre-existing bolt holes formed in said motorcycle to maintain an exposed upper surface of said rear fender.

9. The positioning system of claim 1, wherein said carriage and riser further comprise:
a first carriage portion slidably coupled to said mounting assembly and configured to support said utility, wherein said first carriage portion comprises said range of travel; and
a second carriage portion associated with said utility and removably coupled to said first carriage portion, and having said riser operable to elevate said utility above an upper surface of said rear fender.

10. The positioning system of claim 9, wherein said locking device extends outwardly from a side of said second carriage portion to engage one of said first and second side mounts.

11. The positioning system of claim 9, wherein said second carriage portion is removably coupled to said first carriage portion with a coupling device affixed to an interior face of said second carriage portion.

12. A positioning and seating system operable about a motorcycle for selectively locating a utility in one of a plurality of positions, said positioning and seating system comprising:
a mounting assembly having first and second side mounts securable about opposing sides of a rear fender of a motorcycle;
a carriage slidably coupled to said mounting assembly and configured to support said utility;
a riser operable to elevate said carriage above an upper surface of said rear fender;
a locking device such that said carriage may be locked in a plurality of forward and rearward positions above said rear fender; and
a passenger seat removably interfacing with said upper surface of said rear fender upon said carriage being displaced sufficiently rearward to expose an adequate portion of said upper surface of said fender.

13. The positioning and seating system of claim 12, wherein said passenger seat directly contacts said upper surface of said rear fender.

14. The positioning and seating system of claim 12, wherein said carriage comprises a range of travel defined by a centerline of said carriage that translates about at least the entire length of said side mounts between a most forward position and a most rearward position.

15. The positioning and seating system of claim 12, wherein said carriage is slidably coupled to said mounting assembly using linear bearings having a range of motion that operates to cantilever said carriage at least 50% of the length of said carriage beyond a rear-most portion of said side mounts.

16. The positioning and seating system of claim 12, wherein a position of said carriage within said range of travel is variable at least one of incrementally and continuously between said most forward position and said most rearward position.

17. The positioning and seating system of claim 12, wherein said utility comprises a back support operable with said carriage to selectively provide posterior support to a rider of said motorcycle when said carriage is located in a forward position, and to provide posterior support to a passenger of said motorcycle when said carriage is located in a rearward position.

18. The positioning and seating system of claim 17, wherein said utility comprises a storage container operable with said carriage, and wherein said storage container comprises a back support supported about and extending from said storage container.

19. The positioning and seating system of claim 12, wherein said first and second side mounts are securable about said opposing sides of said rear fender using pre-existing bolt holes formed in said motorcycle to maintain an exposed upper surface of said rear fender.

20. The positioning and seating system of claim 12, wherein said carriage and riser further comprise:
a first carriage portion slidably coupled to said mounting assembly and configured to support said utility, wherein said first carriage portion comprises said range of travel; and
a second carriage portion associated with said utility and removably coupled to said first carriage portion, and having said riser operable to elevate said utility above an upper surface of said rear fender.

21. A method of displacing a utility about a rear fender of a motorcycle comprising:
operating a positioning system mounted to said motorcycle about a rear fender, that is operable to locate a carriage configured to support said utility in one of a plurality of positions about said rear fender of said motorcycle;
positioning said carriage and said utility in a rearward position sufficient to expose said upper surface of said fender;
attaching a separate, supplemental passenger seat configured to removably interface with said upper surface of said rear fender when said carriage and utility are located in said rearward position; and
adjusting said carriage and said utility to provide desired posterior support to a passenger of said motorcycle.

22. The method of claim 21, wherein said positioning system comprises:
a mounting assembly having first and second side mounts securable to opposing sides of a rear fender of a motorcycle;
said carriage slidably coupled to said mounting assembly and configured to support said utility;
a riser operable to elevate said carriage above an upper surface of said rear fender; and
a locking device such that said carriage may be locked in a plurality of forward and rearward positions above said rear fender.

23. The method of claim 21, wherein said carriage comprises a range of travel defined by a centerline of said carriage that translates about at least the entire length of said side mounts between a most forward position and a most rearward position.

24. The method of claim 21, wherein said utility comprises a back support operable with said carriage to selectively provide posterior support to a rider of said motorcycle when said carriage is located in a forward position, and to provide posterior support to a passenger of said motorcycle when said carriage is located in a rearward position.

25. The method of claim 21, wherein operating a positioning system further comprises removably coupling a second carriage portion associated with said utility to a first carriage portion operable with said positioning system mounted about said rear fender, and forming a carriage that is operable to locate said utility in one of a plurality of positions.

26. The method of claim 21, further comprising:
removing said passenger seat;
repositioning said carriage and said utility in a forward position; and
adjusting said carriage and said utility to provide desired posterior support to a rider of said motorcycle.

27. A method of displacing a utility about a rear fender of a motorcycle comprising:
removably coupling a second carriage portion associated with said utility to a first carriage portion operable with a positioning system mounted to said motorcycle about a rear fender, and forming a carriage assembly that is operable to locate said utility in one of a plurality of positions about said fender of said motorcycle;
positioning said carriage assembly and said utility in a rearward position sufficient to expose said upper surface of said fender;
attaching a separate, supplemental passenger seat configured to removably interface with said upper surface with said carriage assembly and utility are located in said rearward position;
adjusting said carriage assembly and said utility to provide desired posterior support to a passenger of said motorcycle; and
interchanging said second carriage portion and associated utility with another second carriage portion associated with a different utility.

28. The method of claim 27, further comprising:
removing said passenger seat;
repositioning said carriage assembly and said utility in a forward position; and
adjusting said carriage assembly and said utility to provide desired posterior support to a rider of said motorcycle.

29. A positioning system operable about a motorcycle for selectively locating an interchangeable utility in one of a plurality of positions, said positioning system comprising:
a mounting assembly having first and second side mounts securable about opposing sides of a rear fender of a motorcycle;
a first carriage portion slidably coupled to said mounting assembly and configured to support said interchangeable utility, wherein said first carriage portion comprises a range of travel defined by a centerline of said first carriage portion that translates about at least the entire length of said side mounts between a most forward position and a most rearward position;
a second carriage portion associated with said interchangeable utility and removably coupled to said first carriage portion, and having a riser operable to elevate said interchangeable utility above an upper surface of said rear fender; and
a locking device such that said first and second carriage portions may be locked together in a plurality of positions above said rear fender.

30. The positioning system of claim 29, wherein said interchangeable utility is selected from the group consisting of a luggage rack having a back support supported about and extending from said luggage rack, and a storage container having a back support supported about and extending from said storage container.
